(19) United States
(12) Patent Application Publication
(10) Pub. No.: US 2012/0097113 A1
(43) Pub. Date: Apr. 26, 2012

(54) TALKING PET TOYS SYSTEM

(76) Inventor: Darlene L. McKinney, Baltimore, MD (US)

(21) Appl. No.: 13/237,480

(22) Filed: Sep. 20, 2011

Related U.S. Application Data
(60) Provisional application No. 61/405,636, filed on Oct. 21, 2010.

(51) Int. Cl. A01K 29/00

(52) U.S. Cl. 119/707

(57) ABSTRACT

A talking pet toys system comprising an audible pet toy for use by a pet, at least one audible speaker; and a DC power source. The pet may include but is not limited to a dog, a cat, or a bird. Further, the audible pet toy comprises an outer covering of material and an inner volume within the outer covering. The inner volume preferably houses stuffing, audible speaker(s), and a DC power source (batteries) contained internally within. The outer covering of the audible pet toy is preferably double-stitched and reinforced so as to be durable in an ‘in-use’ condition such as to withstand repeated dog or cat chewing or bird pecking at the audible pet. In such a manner, audible pet toy may be durable for extended use.

### CROSS-REFERENCE TO RELATED APPLICATION

The present application is related to and claims priority from prior provisional application Ser. No. 61/405,636, filed Oct. 21, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of pet toys and more specifically relates to audible pet toys.

2. Description of the Related Art

Many individuals living in modem society have pets that they raise and care for within their homes. These pets are often dependant on their owners for life's necessities. Another need of animals is entertainment. Playful interaction between the pet and owner is an essential tool in cementing the bond animals and humans share. Entertainment may be as simple as tossing a ball to the family dog, or playfully dangling a fuzzy rope in front of a cat, these activities may provide pets with amusement. Entertainment may be beneficial to an animal's spirit, playing with their owners may also afford pets some much needed exercise and energy release.

Over time, a voluminous amount of toys have been created to amuse pets. Such toys range from bouncy balls to rugged lengths of rope. Other pet toys typically may include stuffed animals or objects, bones, etc. Such toys are chewable allowing for the pet to sink his or her teeth into the toy and to move it from one place to another. Unfortunately these toys do not interact with the animal and may become ‘boring’ after a short duration. Such a toy would be desirable.

Various attempts have been made to solve problems found in audible pet toy art. Among these are found in: U.S. Pat. No. 2007/0295283 to Gick which describes a sound producing pet toy. U.S. Pat. No. 6,578,527 to Mathers which describes a sound generating pet toy. U.S. Pat. No. 6,800,013 to Liu which describes an interactive toy system. U.S. Pat. No. D247,518 to Appel which describes a wind-up audible toy. This prior art is representative of pet toys with sound emitting means.

Ideally, a talking pet toys system should be user-friendly, interactive and, yet would operate reliably and be manufactured at a modest expense. Thus, a need exists for an interactive pet toy that may emit a plurality of pre-programmed sounds and to avoid the above-mentioned problems.

### BRIEF SUMMARY OF THE INVENTION

In view of the foregoing disadvantages inherent in the known pet toys art, the present invention provides a novel audible pet toy. The general purpose of the present invention, which will be described subsequently in greater detail, is to provide a durable stuffed pet toy with an integrated audio player that may emit an assortment of human and miscellaneous sounds such that a pet may be entertained.

The present invention, talking pet toys systems, as disclosed herein, preferably comprises: a pet toy for use by pets, preferably including at least one audible speaker; a DC power source; and an on/off switch preferably concealed beneath the outer covering of material of the pet toy. The pet toy system may be ideal for use with a dog, cat, or bird (other such pets). The pet toy preferably comprises an outer (durable) covering of material and an inner volume housed within the outer covering. The inner volume preferably has stuffing, the audible speaker, and the DC power source contained internally within the outer covering. Further, the outer covering of the pet toy may be double-stitched and reinforced so as to be durable in use by the pet over an extended duration.

The DC power source provides power to activate the speaker(s). The DC power source is in electrical communication with the audible speaker(s) via wires such that at least one electrical signal can be communicated via the wires to the audible speaker(s). The on/off switch controls the DC power source to activate the pet toy by at least one squeezing and/or manipulating motion (by the pet and/or human), thereby creating at least one entertaining activation. The entertaining activation, once activated (by squeezing or manipulating), if left inactive wherein no response is made for more than 60 seconds by the pet, (the pet toy) automatically turns off to conserve the DC power source.

The audible speaker in preferred embodiments may comprise a shatterproof casing and comprises pre-recorded sounds and messages that are playable to entertain the pet. The audible speaker may be (pre-) programmed to emit a human voice with the human voice being audibilized in a male and/or female tone with at least one word or phrase so as to entertain the pet. Additionally, the audible speaker may be (pre-) programmed to emit animal noises, environmental sounds, or pre-recorded music.

Pet toy may take the shape of a minor wherein the minor will talk back to the pet saying for example ‘who's the pretty one when the pet manipulates or touches the minor, with the minor sitting on a flat surface.

In accordance with the embodiments of the present invention a preferred method of use is disclosed herein comprising: step one selecting one or more pet toys in a user-preferred size and shape for play by a pet of the user; step two activating the pet toy; step three playing with said pet using said pet toy, or engaging said pet in a free-spirited game of play to entertain said pet; and step four de-activating the pet toy when the pet is finished playing.

The present invention holds significant improvements and serves as a talking pet toys system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, talking pet toys systems, constructed and operative according to the teachings of the present invention.

FIG. 1 shows a perspective view illustrating a talking pet toys system in an ‘in-use’ condition according to an embodiment of the present invention.

FIG. 2 shows a perspective view illustrating an audible pet toy of the talking pet toys system according to an embodiment of the present invention.

FIG. 3 shows another perspective view illustrating the audible pet toy of the talking pet toys system according to an embodiment of the present invention.

FIG. 4 shows another perspective view illustrating the audible pet toy of the talking pet toys system according to an embodiment of the present invention.

FIG. 5 shows a perspective view illustrating an alternate embodiment of the talking pet toys systems according to an embodiment of the present invention.

FIG. 6 is a flowchart illustrating a method of use for the audible pet toy of the talking pet toys system according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to pet toys and more particularly to audible pet toys with an integrated audio component as used to improve the interactive nature of pet toys.

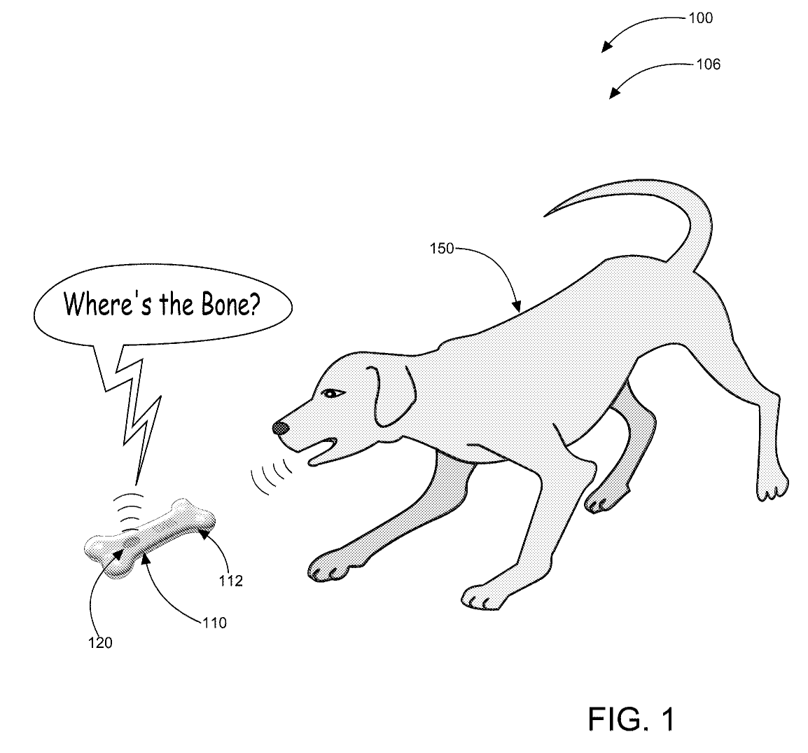

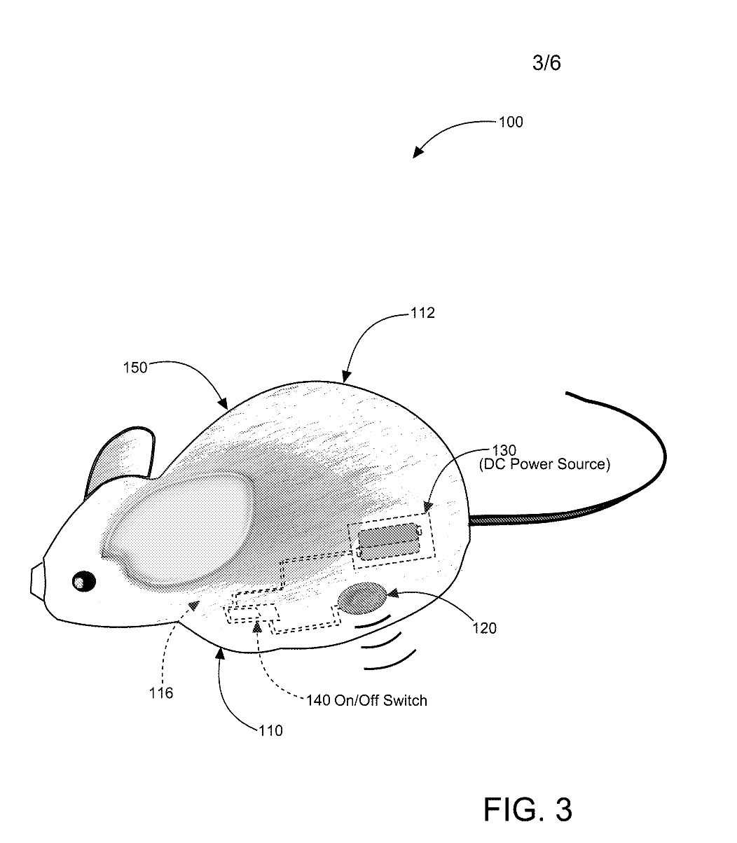

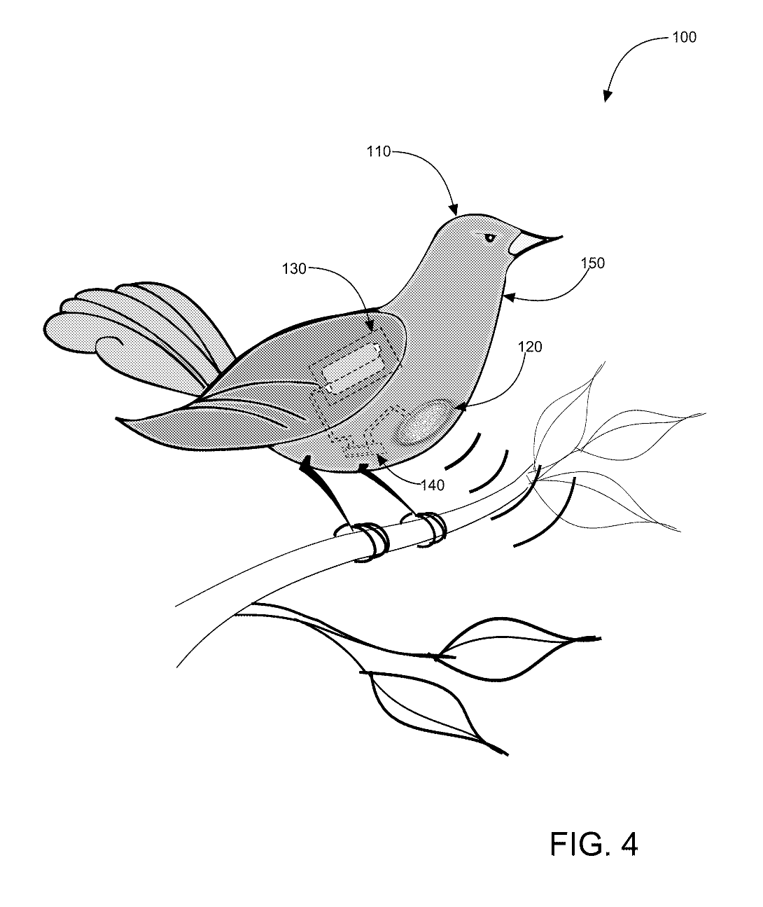

Referring now to FIG. 1 showing a perspective view of talking pet toys system 100 in ‘in-use’ condition 106 according to embodiment(s) of the present invention. Talking pet toys system 100 preferably comprises audible pet toy 110 for use by pet 150, at least one audible speaker 120; and DC power source 130. Pet 150 may include but is not limited to a dog (FIGS. 1 & 2), a mouse (FIG. 3), or a bird (FIG. 4). Further, audible pet toy 110 comprises outer covering 112 of material and inner volume 116 within outer covering 112. Inner volume 116 preferably houses stuffing, audible speaker 120, and DC power source 130 contained internally within. The stuffing used to manufacturer audible pet toy 110 preferably utilizes state of the art material as presently used in the stuffed animal industry. Outer covering 112 of audible pet toy 110 is preferably double-stitched and reinforced so as to be durable in ‘in-use’ condition 106 such as the dog or cat chewing on audible pet toy 110 or the bird pecking at audible pet toy 110. In such a manner, audible pet toy 110 may withstand a greater amount of force and roughness from pet 150 when in ‘in-use’ condition 106.

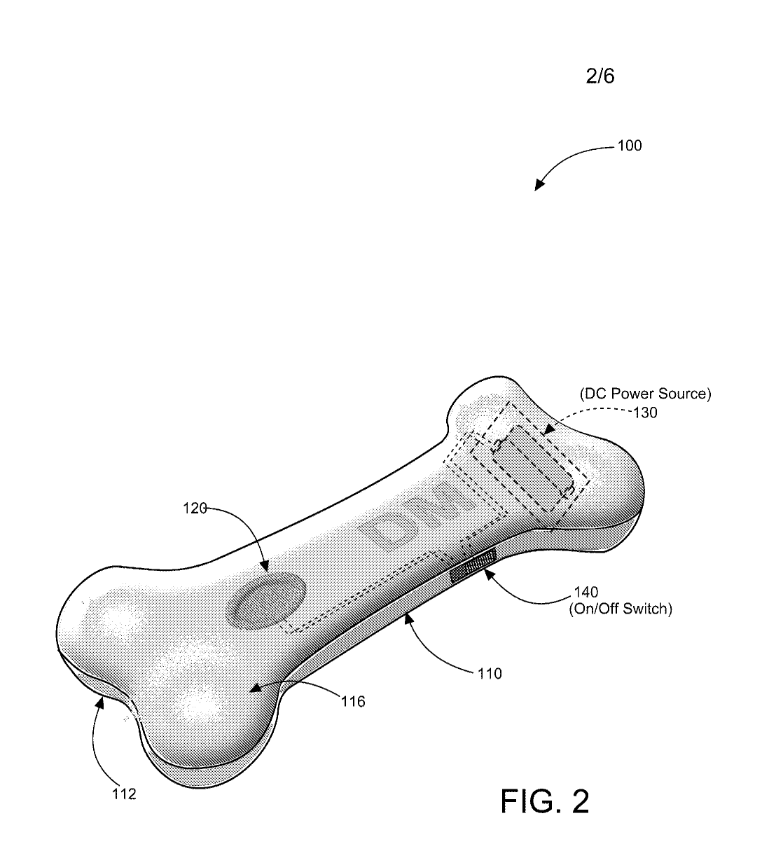

Referring now to FIGS. 2-4 showing perspective views of talking pet toys system 100 in ‘in-use’ condition 106 according to embodiments of the present invention.

Audible pet toy 110 may generally comprise a variety of pet-friendly shapes, sizes, colors, and forms, such as a dog bone as shown in FIGS. 1 & 2 a mouse as shown in FIG. 3, or a bird as shown in FIG. 4. However, it should be noted that other designs and sizes may be manufactured. For example, audible pet toy 110 may take the shape of a ball, a stick, a length of rope, newspapers, horseshoes, or a stuffed animal to name a few. Also, audible pet toy 110 may be manufactured in a wide array of sizes including but not limited to small, medium, and large, depending on the size and need of pet 150. Audible pet toy 110 may be custom-created based on user preference. Additionally, to increase product safety for pet 150, the integrated audio component (audible speaker 120) may be securely housed within audible pet toy 110 and may further comprise a shatterproof casing providing maximum protection and increased durability.

To activate power to audible speaker 120, a DC power source is provided. The DC power source is in electrical communication with audible speaker 120 via wires such that at least one electrical signal can be communicated via the wires to audible speaker 120. The DC power source may comprise batteries for example, however other forms of DC power may be used. It should also be appreciated that wireless technology may be used.

Further, concealed beneath outer covering 112 of material of audible pet toy 110 is on/off switch 140. On/off switch 140 preferably controls the DC power source to activate pet toy 110 by at least one squeezing and/or manipulating motion by pet, thereby creating at least one entertaining activation. The entertaining activation, once activated if left inactive wherein no response is made for more than 60 seconds by pet 150 (or owner), audible pet toy 110 automatically turns off to conserve the DC power source, however if audible pet toy 110 is used by pet 150 that is young, such as a puppy or kitten, audible pet toy 110 may be left inactive for longer than 60 seconds.

Further, audible speaker 120 preferably is (pre-) programmed to emit pre-recorded sounds and messages in the form of audibilized voices for example that are playable to entertain pet 150. The audibilized voices may come in female soothing voices and/or male tones in the form of at least one word or phrase that may be for example of a more playful nature. Various words or saying may be used such as for example “good boy”; “good dog”, “come get me” or other such comforting or playful noises. In this way talking pet toys system 100 serves to promote interaction from the animal playing with the device.

The integrated audio component may be programmed to store a plethora of sounds. In use, pet 150 may chew, rough house, and manipulate audible pet toy 110 with the mouth and paws. With each contact, audible speaker 120 may be triggered to emit a wide array of amusing sounds. The different sounds may simulate environmental noises, such as barking dogs, or purring kittens, or the sounds may simulate a male or female human voice in addition to nature and animal noises. These types of environmental sounds may help sooth pet 150 that may be young who has just been weaned from their mother.

Further, audible pet toy 110 may emit pre-recorded music such as, for example when audible pet toy 110 is in the form of a hound dog toy, a couple of stanzas of Elvis' Hound Dog song may play. When audible pet toy 110 is in the form of a Christmas theme, Christmas songs may be used and played through audible speaker 120. When audible pet toy 110 is in the form of a summer theme, beach songs played through audible speaker 120. Lastly, when audible pet toy 110 is in the form of a wild animal, jungle/animal songs may be used and played through audible speaker 120. It should be noted that any pre-recorded words or phrases may also be sung for entertaining pet 150. Pet 150 may interact with audible pet toy 110 and may be amused for an extended period of time by audible speaker 120 emitting an array of different sounds to the astonishment and delight of pet 150.

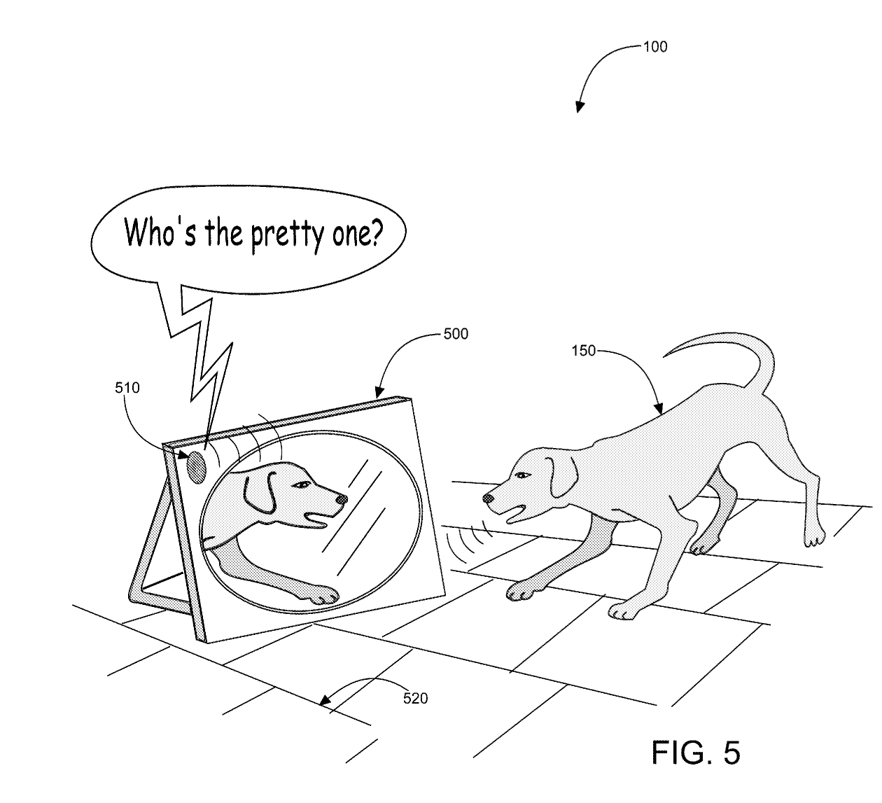

Referring now to FIG. 5 showing a perspective view illustrating an alternate embodiment of talking pet toys systems 100 according to an embodiment of the present invention. In this embodiment, talking pet toys systems 100 preferably comprises audible minor 500. Audible minor 500 also comprises audible speaker 510 and when pet 150 manipulates or touches audible minor 500, audible minor 500 may talk back to pet 150 with the phrase “who's the pretty one?” (or other.) Audible minor 500 may sit on planar surface 520, as shown. Planar surface 520 may include a floor or countertop or the like. Further, audible minor 500 may comprise pet-safe material and have a non slip bottom to help retain it in an upright position. Minor 500 in other embodiments may be integral with pet toy 110.

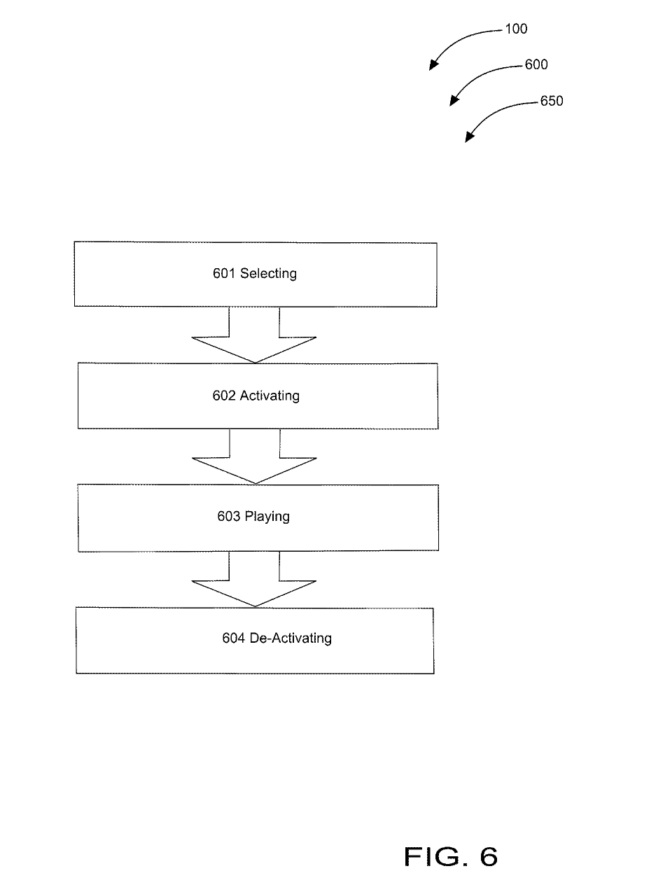

FIG. 6. shows flowchart 650 illustrating method of use 600 according to an embodiment of the present invention of FIGS. 1-5. A method of using (at least herein enabling method of use 600) talking pet toys system 100 may comprise the steps of: step one 601 selecting one or more audible pet toy 110 in a user-preferred size and shape for play by pet 150 of the user; step two 602 activating audible pet toy 110; step three 603 playing with audible pet toy 110 with pet 150, or engaging pet 150 in a free spirited game of play to entertain pet 150; and step four 604 de-activating audible pet toy 110 when pet 150 is finished playing.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An audible pet toy system comprising:
a pet toy for use by a pet, wherein said pet comprises a dog, cat, or bird;
at least one audible speaker; and
a DC power source;
wherein said pet toy comprises an outer covering of material and an inner volume within said outer covering, said inner volume having stuffing, said audible speaker, and said DC power source contained internally within,
wherein said DC power source provides power to activate said at least one audible speaker;
wherein said DC power source is in electrical communication with said at least one audible speaker via wires and/or is wireless communicator such that at least one electrical signal can be communicated via said wires and/or said wireless communicator to said at least one audible speaker; and
wherein said audible speaker comprises pre-recorded sounds and messages that are playable upon a pet's interaction by squeezing and/or manipulating said pet toy to entertain said pet.

2. The audible pet toy system of claim 1 wherein said outer covering of said pet toy is double-stitched and reinforced so as to be durable in use by said pet.

3. The audible pet toy system of claim 1 wherein said pet toy comprises a bone for use by said dog.

4. The audible pet toy system of claim 1 wherein said pet toy comprises a horseshoe.

5. The audible pet toy system of claim 1 wherein said pet toy comprises a mouse for use by said cat.

6. The audible pet toy system of claim 1 wherein said pet toy comprises a ball.

7. The audible pet toy system of claim 1 wherein said pet toy comprises a bird.

8. The audible pet toy system of claim 1 further comprising an on/off switch concealed beneath said outer covering of material of said pet toy.

9. The audible pet toy system of claim 8 wherein said on/off switch controls said DC power source to activate said pet toy by at least one squeezing and/or manipulating motion by said pet, thereby creating at least one entertaining activation.

10. The audible pet toy system of claim 9 wherein said entertaining activation, once activated if left inactive wherein no response is made for more than 60 seconds by said pet, said pet toy automatically turns off to conserve said DC power source.

11. The audible pet toy system of claim 1 wherein said audible speaker(s) comprises a shatterproof casing.

12. The audible pet toy system of claim 1 wherein said audible speaker is programmed to emit a human voice, said human voice audibilized in a male and/or female tone with at least one word or phrase so as to entertain said pet.

13. The audible pet toy system of claim 1 wherein said audible speaker is programmed to emit animal noises.

14. The audible pet toy system of claim 1 wherein said audible speaker is programmed to emit environmental sounds.

15. The audible pet toy system of claim 1 wherein said audible speaker is programmed to emit pre-recorded music.

16. The audible pet toy system of claim 8 wherein when said pet toy takes the shape of at least one mirror wherein said minor will talk back to said pet saying ‘who's the pretty one when said pet manipulates or touches said mirror, with said minor sitting on a flat surface, said minor having a grip surface.

17. An audible pet toy system comprising:
a pet toy for use by a pet, wherein said pet comprises a dog, cat, or bird;
at least one audible speaker;
a DC power source; and
an on/off switch hidden beneath said outer covering of material of said pet toy;
wherein said pet toy comprises an outer covering of material and an inner volume within said outer covering, said inner volume having stuffing, said audible speaker, and said DC power source contained internally within;
wherein said outer covering of said pet toy is double-stitched and reinforced so as to be durable in use by said pet;
wherein said DC power source provides power to activate said at least one audible speaker;
wherein said DC power source is in electrical communication with said at least one audible speaker via wires such that at least one electrical signal can be communicated via said wires to said at least one audible speaker; and
wherein said audible speaker comprises pre-recorded sounds and messages that are playable upon a squeezing action and/or a manipulating action via said pet to entertain said pet;
wherein said on/off switch controls said DC power source to activate said pet toy by at least one squeezing and/or a manipulating motion by said pet, thereby creating at least one entertaining activation;
wherein said entertaining activation, once activated if left inactive wherein no response is made for more than 60 seconds by said pet, said pet toy automatically turns off to conserve said DC power source;
wherein said audible speaker comprises a shatterproof casing; and
wherein said audible speaker is programmed to emit a human voice, said human voice audibilized in a male and/or female tone or animal noises with at least one word or phrase or sound so as to entertain said pet.

18. A method of using an audible pet toy system comprising the steps of:
selecting one or more pet toys in a user-preferred size and shape for play by a pet of said user;
activating said pet toy;
playing with said pet using said pet toy, or engaging said pet in a free-spirited game of play to entertain said pet; and
de-activating said pet toy when said pet is finished playing.
